(19) United States
(12) Patent Application Publication
(10) Pub. No.: US 2012/0283991 A1
(43) Pub. Date: Nov. 8, 2012

(54) Method and System for Online Detection of Multi-Component Interactions in Computing Systems

(75) Inventors: Adam J. Oliner, San Francisco, CA (US); Alex Aiken, Stanford, CA (US)

(73) Assignee: The Board of Trustees of the Leland Stanford, Junior, University, Palo Alto, CA (US)

(21) Appl. No.: 13/102,921

(22) Filed: May 6, 2011

(51) Int. Cl. G06F 11/30

(52) U.S. Cl. 702/186

(57) ABSTRACT

A method of the present invention provides an efficient, two-stage, online method for discovering interactions among components and groups of components, including time-delayed effects, in large production systems. The first stage compresses a set of anomaly signals using a principal component analysis and passes the resulting eigensignals and a small set of other signals to the second stage, a lag correlation detector, which identifies time-delayed correlations. Real use cases are described from eight unmodified production systems.

### STATEMENT OF GOVERNMENT SPONSORED SUPPORT

This invention was made with Government support under contract 0915766 awarded by the National Science Foundation. The Government has certain rights in this invention.

### FIELD OF THE INVENTION

The present invention generally relates to the field of computer diagnostics. More particularly, the present invention relates to an online method for detecting component interactions in computing systems.

### BACKGROUND OF THE INVENTION

There is previous work on system modeling, especially on inferring the causal or dependency structure of distributed systems. Previous work on dependency graphs typically assumes that a system can be perturbed (e.g., by adding instrumentation or active probing), that a user can specify the desired properties of a healthy system, that the user has access to the source code, or a combination of these. In practice, however, none of these assumptions may be true.

One common thread in dependency modeling work is that the system must be actively perturbed by instrumentation or by probing. Communication dependencies can be tracked with the aim of isolating the root cause of misbehavior. This analysis requires instrumentation of the application to tag client requests. In order to determine the causal relationships among messages, message traces can be used and dependency paths computed. Binary instrumentation can be used to perform online predicate checks. Other work leverages tight integration of the system with custom instrumentation to improve diagnosability or restrict the tool to particular kinds of systems. Deterministic replay is another common approach but requires supporting instrumentation. In many applications, these existing methods cannot be applied and it is neither possible nor practical to add additional instrumentation.

Some approaches require the user to write predicates indicating what properties should be checked. Such an approach identifies when communication patterns differ from expectations and requires an explicit specification of those expectations.

Other work shows how access to source code can facilitate tasks like log analysis and distributed diagnosis. For example, certain work has used principal component analysis in their work to identify anomalous event patterns rather than finding related groups of real-valued signals.

### SUMMARY OF THE INVENTION

Many interesting problems in systems arise when components are connected or composed in ways not anticipated by their designers. As systems grow in scale, the sparsity of instrumentation and complexity of interactions increases. Among other things, the present invention infers a broad class of interactions in unmodified production systems, online, using existing instrumentation.

For example, the methods of the present invention look for correlated behavior called influence rather than dependencies. Two components share an influence if there is a correlation in their deviations from normal behavior; influence is orthogonal to whether or not the components share dependencies. Influence is statistically robust to noisy or missing data and captures implicit interactions like resource contention and has provided a high-level query language. Among other things, the method of the present invention can compute both the strength and directionality (time delay) of influence online, scale to tens of thousands of signals, and apply this method to a variety of administration tasks.

In an embodiment, the method of the present invention, uses an online principal component analysis (PCA). This analysis makes assumptions about the input data and has good performance and scalability characteristics. Among other things, the present invention does the following: uses PCA for dimensionality reduction to make the lag correlation scalable; analyzes anomaly signals rather than raw data as the input to permit the comparison of heterogeneous components and the encoding of expert knowledge; adds a mechanism for bypassing the PCA stage for standing queries; and, applies these techniques in the context of understanding production systems.

These and other embodiments can be more fully appreciated upon an understanding of the detailed description of the invention as disclosed below in conjunction with the attached Figures.

### BRIEF DESCRIPTION OF THE DRAWINGS

The following drawings will be used to more fully describe embodiments of the present invention.

FIG. 1 illustrates an exemplary networked environment and its relevant components according to aspects of the present invention.

FIG. 2 is an exemplary block diagram of a computing device that may be used to implement aspects of certain embodiments of the present invention.

FIG. 3A depicts a block diagram relating to a system according to an embodiment of the present invention.

FIG. 3B depicts a flow chart relating to method according to an embodiment of the present invention.

FIG. 4 depicts certain results of an application of the present invention: Using prefixes of Stanley's data (n=16), we see that compression rate is not a function of the number of ticks.

FIG. 5 depicts certain results of an application of the present invention: The lag correlation computation is not a function of the number of ticks (n=20). Each pair of data points corresponds to one of our studied systems.

FIG. 6 depicts certain results of an application of the present invention: The rate of ticks per second for the compression stage decreases slowly with the number of signals; autoregressive weighting (decay) has no effect on running time.

FIG. 7 depicts certain results of an application of the present invention: Although the compression rate decreases with the number of signals, larger systems tend to update measurements less frequently. The ratio between compression rate and measurement generation rate, plotted, shows that the bigger systems are easier to handle than the 25 ticks-per-second data rate of the embedded systems.

FIG. 8 depicts certain results of an application of the present invention: The rate of lag correlation processing decreases quickly with the number of signals. (Note the log-log scale.) An embodiment of the present invention uses eigensignals and a watch list to keep the number of signals small.

FIG. 9 depicts certain results of an application of the present invention: The cumulative fraction of total energy in Stanley's first k eigensignals. The bottom line shows the energy captured by the first eigensignal. The line above that is for the first two eigensignals, etc.

FIG. 10 depicts certain results of an application of the present invention: The incremental additional energy captured by Stanley's kth eigensignal, given the first k−1.

FIG. 11 depicts certain results of an application of the present invention: The cumulative fraction of total energy in BG/L's first k eigensignals. The first ten eigensignals suffice to describe more than 90% of the energy in the system's 69,087 signals.

FIG. 12 depicts certain results of an application of the present invention: The fraction of energy captured by the first 20 eigensignals, plotted versus the size of those signals as a fraction of the total input data. (Note that Stanley only has 16 components and therefore only 16 eigensignals.)

FIG. 13 depicts certain results of an application of the present invention: When old data is allowed to be forgotten (decay), the behavior of the system can be described efficiently using a small number of eigensignals.

FIG. 14 depicts certain results of an application of the present invention: Weights for Stanley's first three subsystems. The left bar indicates the absolute weight of that signal's contribution to the subsystem; the second bar indicates its weight in the second subsystem, etc.

FIG. 15 depicts certain results of an application of the present invention: Weights of Stanley's first three subsystems, with decay. The subsystem involving the lasers (see FIG. 14) has long since decayed because the relevant anomalies happened early in the race.

FIG. 16 depicts certain results of an application of the present invention: Weights of Spirit's first subsystem, sorted by weight magnitude. The compression stage has identified a phenomenon that affects many of the components.

FIG. 17 depicts certain results of an application of the present invention: Sorted weights of Spirit's third subsystem. Most of the weight is in a small subset of the components.

FIG. 18 depicts certain results of an application of the present invention: The anomaly signals of the representatives of the first three subsystems for the SQL cluster.

FIG. 19 depicts certain results of an application of the present invention: Reconstruction of a portion of Liberty's admin signal using the subsystems, including the periodic anomalies.

FIG. 20 depicts certain results of an application of the present invention: Reconstruction of a portion of Liberty's R_EXT_CCISS indicator signal with decay.

FIG. 21 depicts certain results of an application of the present invention: Relative reconstruction error for the SQL cluster, with and without decay. Reconstruction is more accurate when old values decay, especially during a new phase near the end of this log.

FIG. 22 depicts certain results of an application of the present invention: In the SQL cluster, the strongest lag correlation was found between the third and fourth subsystems, with a magnitude of 0.46 and delay of 30 minutes. These eigensignals and their representatives' signals (disk and swap, respectively), are shown above.

FIG. 23 depicts certain results of an application of the present invention: An embodiment of the present invention reports that the signal swap tends to spike 210 minutes before interrupts, with a correlation of 0.271; we can detect this online.

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

Further, certain Figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” should be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

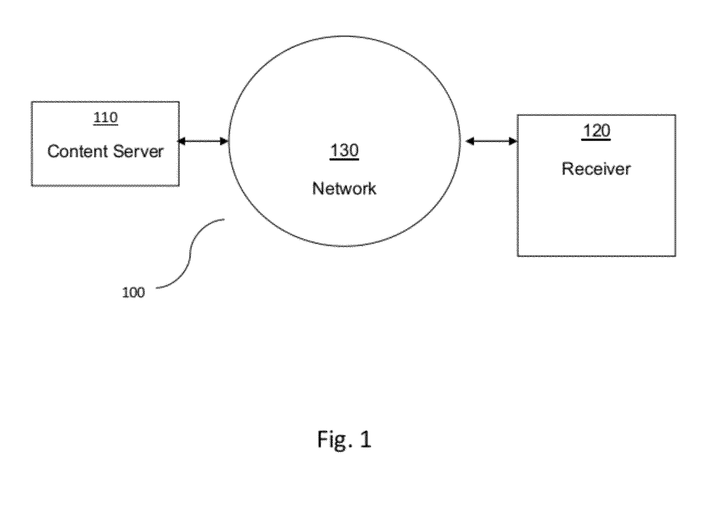

FIG. 1 depicts an exemplary networked environment 100 in which systems and methods, consistent with exemplary embodiments, may be implemented. As illustrated, networked environment 100 may include a content server 110, a receiver 120, and a network 130. The exemplary simplified number of content servers 110, receivers 120, and networks 130 illustrated in FIG. 1 can be modified as appropriate in a particular implementation. In practice, there may be additional content servers 110, receivers 120, and/or networks 130.

In certain embodiments, a receiver 120 may include any suitable form of multimedia playback device, including, without limitation, a computer, a gaming system, a cable or satellite television set-top box, a DVD player, a digital video recorder (DVR), or a digital audio/video stream receiver, decoder, and player. A receiver 120 may connect to network 130 via wired and/or wireless connections, and thereby communicate or become coupled with content server 110, either directly or indirectly. Alternatively, receiver 120 may be associated with content server 110 through any suitable tangible computer-readable media or data storage device (such as a disk drive, CD-ROM, DVD, or the like), data stream, file, or communication channel.

Network 130 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of suitable network, depending on the requirements of each particular implementation.

One or more components of networked environment 100 may perform one or more of the tasks described as being performed by one or more other components of networked environment 100.

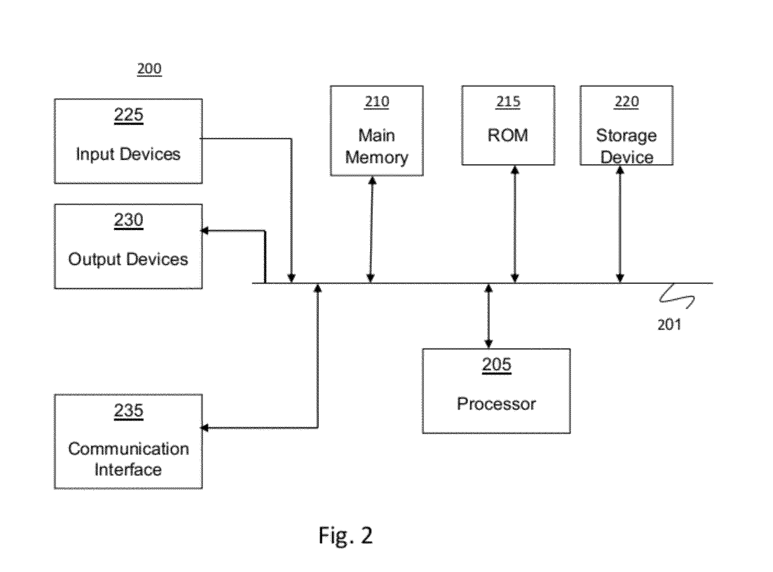

FIG. 2 is an exemplary diagram of a computing device 200 that may be used to implement aspects of certain embodiments of the present invention, such as aspects of content server 110 or of receiver 120. Computing device 200 may include a bus 201, one or more processors 205, a main memory 210, a read-only memory (ROM) 215, a storage device 220, one or more input devices 225, one or more output devices 230, and a communication interface 235. Bus 201 may include one or more conductors that permit communication among the components of computing device 200.

Processor 205 may include any type of conventional processor, microprocessor, or processing logic that interprets and executes instructions. Moreover, processor 205 may include processors with multiple cores. Also, processor 205 may be multiple processors. Main memory 210 may include a random-access memory (RAM) or another type of dynamic storage device that stores information and instructions for execution by processor 205. ROM 215 may include a conventional ROM device or another type of static storage device that stores static information and instructions for use by processor 205. Storage device 220 may include a magnetic and/or optical recording medium and its corresponding drive.

Input device(s) 225 may include one or more conventional mechanisms that permit a user to input information to computing device 200, such as a keyboard, a mouse, a pen, a stylus, handwriting recognition, voice recognition, biometric mechanisms, and the like. Output device(s) 230 may include one or more conventional mechanisms that output information to the user, including a display, a projector, an A/V receiver, a printer, a speaker, and the like. Communication interface 235 may include any transceiver-like mechanism that enables computing device/server 200 to communicate with other devices and/or systems. For example, communication interface 235 may include mechanisms for communicating with another device or system via a network, such as network 130 as shown in FIG. 1.

As will be described in detail below, computing device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present invention. Thus, various implementations are not limited to any specific combination of hardware circuitry and software.

A web browser comprising a web browser user interface may be used to display information (such as textual and graphical information) on the computing device 200. The web browser may comprise any type of visual display capable of displaying information received via the network 130 shown in FIG. 1, such as Microsoft's Internet Explorer browser, Netscape's Navigator browser, Mozilla's Firefox browser, PalmSource's Web Browser, Google's Chrome browser or any other commercially available or customized browsing or other application software capable of communicating with network 130. The computing device 200 may also include a browser assistant. The browser assistant may include a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the computing device 200 and/or the network 130. For example, source data or other information received from devices connected to the network 130 may be output via the browser. Also, both the browser and the browser assistant are capable of performing operations on the received source information prior to outputting the source information. Further, the browser and/or the browser assistant may receive user input and transmit the inputted data to devices connected to network 130.

Similarly, certain embodiments of the present invention described herein are discussed in the context of the global data communication network commonly referred to as the Internet. Those skilled in the art will realize that embodiments of the present invention may use any other suitable data communication network, including without limitation direct point-to-point data communication systems, dial-up networks, personal or corporate Intranets, proprietary networks, or combinations of any of these with or without connections to the Internet.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the art would be familiar with such details.

In the present disclosure, we are interested in automatic support for understanding large production systems such as supercomputers, data center clusters, and complex control systems. Fundamentally, administrators of such systems need to understand what parts of a computer system affect another part. In certain situations, changes in the computer system may be the manifestation of a system bug and the administrator may be looking for its cause, but administrators also need to answer understand the effects that resource utilization (e.g., the elimination of performance problems), global or local unexplained behavior, and even what aspects of the system should be monitored (with the aim of logging useful data), among other things.

There are severe constraints on any solution to this problem:
1) Lack of specification. In practice, there may be no description of the correct behavior of the system. In fact, in all the systems we have studied, there has been no list of all the system's components and their interactions—even the administrators are unaware of what is inside some parts of the system (e.g., third-party subsystems may be black boxes). Administrators do have rules of thumb and lists of known bad behaviors that they watch monitor; but they also realize these lists are incomplete.
2) Minimally invasive monitoring. For reasons of cost, performance, and system stability, administrators are generally unwilling to disturb the inner workings of system components for the purposes of better monitoring. It is often possible to add new logging of inputs and outputs to components, but even that must usually be justified as cost-effective for addressing other important issues that cannot be answered using existing logs.
3) Rapid turnaround. Answers to some of the most important questions are only useful if they can be computed in real-time. For example, administrators would like to set standing queries that trigger an alarm when the system first strays into a pattern of behavior that is known to likely lead to problems such as crashing.

In addressing problems 1 and 2 above, we assume only that a subset of the components have logs with time-stamped entries (many system satisfy this requirement). These logs are converted into time-varying signals that are correlated, possibly with a time delay. The strength of the correlation and direction of any delays allow administrators to answer many useful queries about how and when various parts of the system influence each other. In certain applications, however, this computation is performed offline.

An advantage of the present invention is an online method for analyzing and answering questions about large systems. In an embodiment, the present invention implements computing correlations and delays between component signals and further addresses certain semantic and performance requirements to provide a novel online solution. In particular, an embodiment of the present invention implements a combination of online, anytime algorithms that maintain concise models of how components and sets of components are interacting with each other, including the delays or lags associated with those interactions. The method is online in the sense that as instrumentation data is being produced by the system, the method of the present invention has a current estimation of its interactions. In an embodiment, the method works in two pipelined stages: signal compression using a principle component analysis and lag correlation using a combination of conservative approximations.

A computer system such as the computer system shown in FIG. 2 consists of a set of components, some of which are instrumented to record timestamped log entries. These logs are converted into real-valued functions of time called anomaly signals. These anomaly signals encode when measurements differ from typical or expected behavior. The process of converting raw logs into meaningful anomaly signals is how the user encodes what they know about the system as well as what they want to understand. For example, a user might want the anomaly signal to initially highlight an unusual error message and then mute it once the error is understood. System administrators are comfortable with this notion of an exploratory tool that they can adapt to reflect changes in the system, their knowledge of the system, or questions they want to answer. One of ordinary skill in the art understand the process of converting raw measurements into anomaly signals but the present invention extends the anomaly signals to efficiently infer component interactions.

At every time-step or tick in a log, the present invention passes the most recent value of every anomaly signal through a two-stage analysis. The first stage compresses the data by finding correlated groups of signals using an online, approximate principal component analysis (PCA). These component groups can be called subsystems. This analysis produces a new set of anomaly signals, called eigensignals. In an embodiment, one eigensignal corresponds to the behavior of each subsystem. For example, the behavior of the entire system can be summarized using a new and much smaller set of signals that include the eigensignals.

In the second stage, the present invention takes the eigensignals and possibly a small set of additional anomaly signals and looks for lag correlations among them using an online approximation algorithm. Although the eigensignals are mutually uncorrelated by construction, they may be correlated with a lag.

Anomaly signals can be taken from various signals generated in a system. For example, in an embodiment of the invention anomaly signals are taken from a production database (SQL) cluster. For example, anomaly signal disk can be an aggregated signal corresponding to disk activity, anomaly signal forks can correspond to the average number of forked processes; and anomaly signal swap can correspond to the average number of memory pageins.

In the first stage of the analysis of the present invention, the PCA automatically can, for example, find the correlation between anomaly signal disk and anomaly signal forks and generates an eigensignal that summarizes both of the original signals. In the second state of the analysis of the present invention takes as input the eigensignal and anomaly signal swap to determine a correlation: behavior of interest in the subsystem consisting of disk and fork events tends to precede behavior of interest in swap events.

In an implementation, the analysis of the present invention on these and several related signals helped the system's administrator diagnose a performance bug. In the bug, a burst of disk swapping coincided with the beginning of a gradual accumulation of slow queries that, over several hours, crossed a threshold and crippled the server. In addition to helping with a diagnosis, the method of the present invention can give enough warning of the impending collapse for the administrator to take remedial action.

After describing the method of the present invention, we evaluate it using nearly 100,000 signals from eight unmodified production systems, including four supercomputers, two autonomous vehicles, and two data center clusters. The results show that the present invention can efficiently and accurately discover correlations and delays in real systems and in real-time, and that this information is operationally valuable.

### III. Method

In a general sense, the present invention takes a difficult problem—understanding the complex relationships among heterogeneous components generating heterogeneous logs—and transforms it into a well-formed and computable problem: understanding the variance in a set of signals. The input to the method of the present invention is a set of signals for which variance corresponds to behavior lacking a satisfactory explanation.

The first stage of the method of the present invention attempts to explain the variance of one signal using the variance of other signals. In an embodiment, principal component analysis (PCA) is used for this purpose such as described by Papadimitrou et al. in their implementation of SPIRIT. Notably, however, PCA may miss signals that co-vary with a delay or lag.

The second stage of the method of the present invention identifies lagged correlations. In the present disclosure, we demonstrate how to encode and answer certain natural questions about a system in terms of time varying signals. In an embodiment, implements a lag correlation detection algorithm such as Enhanced BRAID developed by Papadimitrou et al.

Consider a system of components in which a subset of these components are generating timestamped measurements that describe their behavior. In an embodiment, these measurements are represented as real-valued functions of time called anomaly signals. Our method consists of two stages that are pipelined together:
(i) an online PCA that identifies the contributions of each signal to the behavior of the system and identifies groups of components with mutually correlated behavior called subsystems and
(ii) an online lag correlation detector that determines whether any of these subsystems are, in turn, correlated with each other when shifted in time.

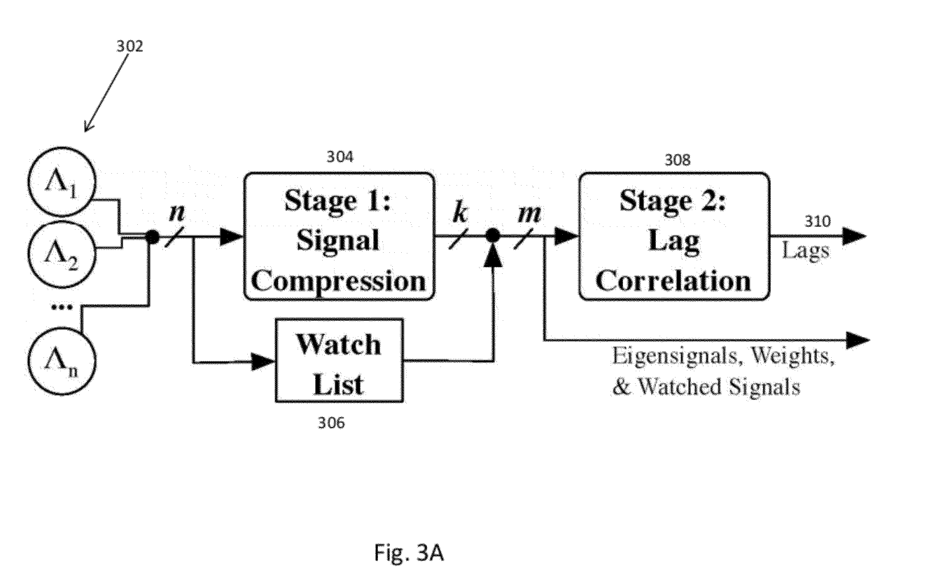

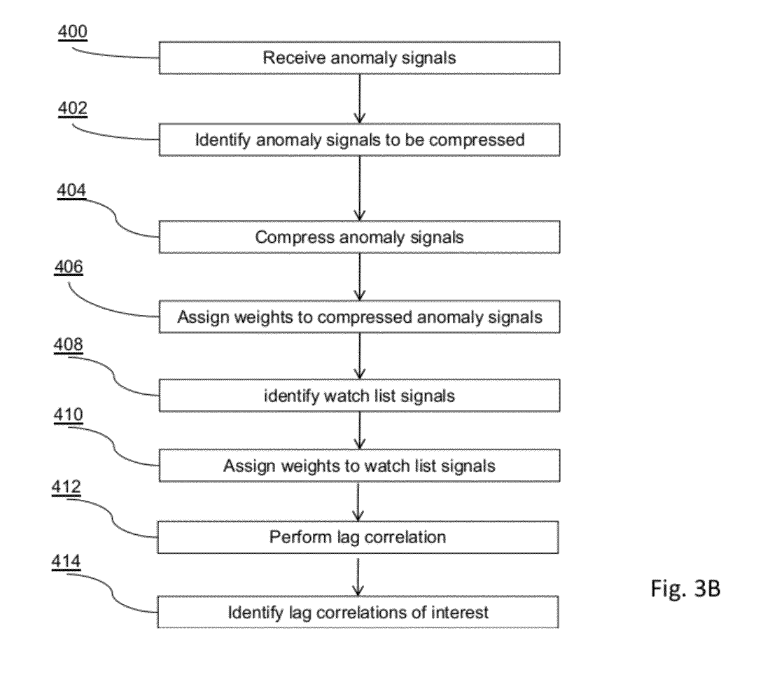

FIG. 3 provides a block diagram overview of the present invention. As shown, n anomaly signals 302 are available for input to the system of the present invention. A first subset of the n anomaly signals are input to signal compression block 304. Among other things, signal compression block 304 outputs k eigensignals that represent a compressed version of at least one subset of the first subset of n anomaly signals. In an embodiment, a further output of signal compression block 304 are weights for the various eigensignals. The eigensigals and the weights can be made available and separately analyze in an embodiment of the present invention. A second subset of the n anomaly signals is input to watch list block 306. In an embodiment of the invention, watch list block 306 provides a weight to the signals of the watch list. In another embodiment, the weights are set to 1. In an embodiment, the signals of the watch list and the associated weights are made available and separately analyzed.

The watch list signals, the eigensignals, and any associated weights are then input to lag correlation block 308. Among other things, lag correlation block introduces lags or delays to certain of the inputted signals to determine whether the signals are correlated in a lagged sense. In an embodiment of the invention, exhaustive lag correlation computations can be performed, but in another embodiment of the invention, lag correlation computations are performed among certain predetermined signals of interest and within certain bounds of lag. This latter implementation can allow for faster results without wasted computational resources. The results of lag correlation block 308 are output at lag output 310. Further details regarding the block diagram of FIG. 3 will be provided further below.

Shown in FIG. 3B is a flowchart of a method according to an embodiment of the invention. At step 400, a method of the present invention receives as input n anomaly signals. At step 402, a subset of the n anomaly signals is identified for compression. At step 404, the identified anomaly signals are compressed and output as k compressed signals. In an embodiment, the anomaly signals are compressed using a principal components analysis. Also, in an embodiment the compressed signals are identified as eigensignals. At step 406, weights are optionally assigned to the k compressed signals. At step 408, anomaly signals are identified as watch list signals. At step 410, weights are optionally assigned to the watch list signals. The eigensignals and the watch list signals are analyzed for lag correlation at step 410. At step 412, lag correlations of interest are identified. In an embodiment, lag correlations with predetermined lag correlations are identified as lag correlations of interest. Further details regarding the method of FIG. 3B will be provided further below.

A. Anomaly Signals

In an embodiment, input to the method of the present invention includes timestamped measurements from components of a system. The measurements from a particular component are used to construct an anomaly signal. The value of an anomaly signal at a given time represents how unusual or surprising the corresponding measurements are. In an embodiment, the further from the signal's average value, the more surprising it is. In an embodiment, the anomaly signal can be a scaled value relative to a mean and standard deviation of a signal. Anomaly signals can hide details of the underlying data that are irrelevant for answering a particular question. Thus, there is no single “correct” anomaly signal, as any feature of the log may be useful for answering a question of interest. The abstraction may only lessen, rather than remove, unwanted characteristics and may unintentionally mute important signals. The purpose of the anomaly signal abstraction, however, is to highlight the behaviors desired to be understood, especially when and where the signals are occurring in the system. Many other measures are possible as would be understood by one of ordinary skill in the art.

Numerical measurements can be directly used as anomaly signals while other measurements may require a processing step to make them numerical. In the absence of any special knowledge about the system or the mechanisms that generated the data, we have found that anomaly signals based on statistical properties (e.g., the frequency of particular words in a textual log) can work well.

Administrators do not typically have a complete specification of expected behavior. For example, systems may be extremely complicated and may change too frequently for such a specification to be constructed or maintained. Instead, administrators may often have short lists of rules about the kinds of events in the logs that are important. Anomaly signals allow them to encode this information.

A single physical or logical component may produce multiple signals, each of which has an associated name. For example, a server named host1 may record bandwidth measurements as well as syslog messages. In such a situation, the corresponding signals can be helpfully named host1-bw and host1-syslog, respectively. A single measurement stream may be used to construct multiple anomaly signals. For example, a text log can have one signal that generally indicates how unusual the messages are and another signal that indicates the presence or absence of a particular message.

We do not assume that all components have at least one signal. In application, we have observed that systems generally have multiple components that are uninstrumented. In fact, it has been observed that administrators may not always be aware of every component. Advantageously, the present invention does not need instrumentation for or knowledge of all components in the system.

1) Derived Signals

In an embodiment of the invention, non-numerical data like log messages or categorical states are converted into anomaly signals. In an embodiment, we use the Nodeinfo algorithm for textual logs and an information-theoretic timing-based model for the embedded systems (autonomous vehicles). Advantageously, both of these algorithms highlight irregularities in the data without requiring a deep understanding of it.

In another embodiment, numerical signals may be optionally processed to encode the aspects of the measurements that are of interest and those that are not. For example, daily traffic fluctuations may increase variance, but this is may not surprising and can, in turn, be filtered out of the anomaly signal.

Although numerical signals can be used directly and there are existing tools for getting anomaly signals out of common data types like system logs, the more expert knowledge the user applies to generate anomaly signals from the data, the more relevant the results of the present invention are.

In an application of the present invention, the administrators of certain systems maintained lists of log message patterns that they believed corresponded to important events. For these, the administrators had a general understanding of system topology and functionality. We now discuss how such information can be used to generate additional anomaly signals from the existing log data.

a) Indicator Signals

In an embodiment, knowledge of interesting log messages can be encoded using a signal that indicates whether a predicate (e.g., a specific component generated a message containing the string ERR in the last five minutes) is true or false. Although this is a simple way to encode expert knowledge about a log, indicator signals have proven to be both flexible and powerful. We provide an example of how indicator signals can elucidate system-wide patterns.

b) Aggregate Signals

In another embodiment, knowledge of system topology signals (e.g., a set of signals are all generated by components in a single machine rack) can be encoded by computing the time-wise average of those signals. This new signal represents the aggregate behavior of the original signals. The time-average of correlated signals will tend to look like the constituent signals while the average of uncorrelated or anti-correlated signals will tend toward a flat line. This has been shown to be a useful way to describe functionally- or topologically-related sets of signals. Also, these aggregate signals often summarize important behaviors.

B. Stage 1: Signal Compression

A system may have thousands of anomaly signals. Accordingly, being able to efficiently summarize them using only a small number of signals with minimal loss of information is valuable to implementation of the present invention.

To compress the anomaly signals with minimal loss of information, the first stage of the present invention performs an approximate, online principal component analysis (PCA). This stage takes the n anomaly signals, where n may be large, and represents them as a small number k of new signals that are linear combinations of the original signals. These new signals, called eigensignals, are computed so that they capture or describe as much of the variance in the original data as possible. The parameter k is set to be as large as computing resources allow to minimize information loss. This stage is online, any-time, single-pass, and does not require any sliding windows or buffering.

In an embodiment, the PCA maintains, for each eigensignal, a vector of weights of length n, where n is the number of anomaly signals. At each tick (time step), for each eigensignal, a vector containing the most recent value of each anomaly signal is projected onto the weight vector to produce a value for the eigensignal. The eigensignals and weights are then used to reconstruct an approximation of the original n signals.

A check ensures the resulting reconstruction has an energy that is sufficiently close to that of the original signals; if not, the weights are adjusted so that they “track” the anomaly signals. The time and space complexity of this method on n signals and k eigensignals is O(nk). An eigensignal and its weights define a behavioral subsystem, e.g., a linear combination of related signals.

Recall the example from above. The first stage groups anomaly signal disk and anomaly signal forks in the same subsystem, and in fact, these two signals are highly correlated. At this point, however, there is no apparent relationship with the anomaly signal swap component. Note that although PCA will tend to group correlated signals because this efficiently explains variance, two signals being in the same subsystem does not imply that they are highly correlated. This can be checked.

Generally, the signals with significant weight in a subsystem are all well-correlated, which is also the justification for picking the most heavily weighted signal in a subsystem as the representative of that subsystem.

1) Decay

The PCA stage of the present invention takes an optional parameter that causes old measurements to be gradually forgotten, so the subsystems will weight recent data more than older data. This decay parameter is set to 1.0 by default, which means all historical data is considered equally in the analysis. Previous work used a decay parameter of 0.96. In our experiments, we say ‘no decay’ to indicate a decay value of 1.0 and ‘decay’ to indicate 0.96. Note, however, that we do not explicitly retain historical data, in either case.

Decay is useful for more closely tracking recent changes and for studying those changes over time; if needed, an instance of the compression stage with decay can be run in parallel to one without. We use no decay except where otherwise indicated.

C. Stage 2: Lag Correlation

The first stage of the method of the present invention extracts correlations among signals that are temporally aligned, but delayed effects or clock skews may cause correlations to be missed. The second stage of the present invention performs an approximate, online search for signals correlated with a lag, that is, signals that are correlated when one is shifted in time relative to the other.

The cross-correlation between two signals gives the correlation coefficients for different lags. In an embodiment, the cross-correlation can be updated incrementally while retaining only a set of sufficient statistics about the two input signals. To reduce the running time, lag is computed only at a subset of lag values, chosen so that smaller lags are computed more densely than larger lags. To reduce space consumption, lags are computed on smoothed approximations of the original signals. These optimizations yield asymptotic speedups and typically introduce little to no error. The running time, per tick, is O(m2), where m is the number of signals. The space complexity is O(m2 log t), where t is the number of ticks.

One of the insights of the present invention is that, without first reducing the dimensionality of the problem, large systems would generate too many signals for lag correlation to be practical. One of the primary purposes of the PCA computation is to perform this dimensionality reduction. Once the problem is reduced to eigensignals and perhaps a small set of other signals, lag correlation can often be computed more quickly than the PCA. In other words, the first stage of the method of the present invention ensures m<<n and makes lag correlation practical for large systems.

Recall the example from above. The lag correlation stage finds a temporal relationship between the subsystem consisting of anomaly signal disk and anomaly signal forks and the anomaly signal swap, specifically that anomalies in the former tend to precede those in the latter.

1) Watch List

In an embodiment, a watch list is generated. The watch list is a small set of signals that, in addition to the eigensignals, will be checked for lag correlations. These signals bypass the compression stage, which enables us to ask questions (standing queries) about specific signals and to associate results with specific components. There are several ways for a signal to end up on the watch list. It may be manually added, for example, it may be added if a user complains that a certain machine has been misbehaving. The signal may also be automatically added by a rule. For example, if the temperature of some component exceeds a threshold, the signal may be automatically added. Also, the signal may be automatically added by selecting representatives for the subsystems. A subsystem's representative signal is the anomaly signal with the largest absolute weight in the subsystem that is not the representative of an earlier (stronger) subsystem. In our experiments, we automatically seed the watch list with the representative of each subsystem.

D. Output

The output of the present invention is the behavioral subsystems, their behavior over time as eigensignals, and lag correlations between those eigensignals and signals on the watch list. The first stage produces k eigensignals and their weights. The second stage produces a list of pairs of signals from among the eigensignals and those on the watch list that have a lag correlation, as well as the values of those lags and correlations. In an embodiment, thresholding can be performed to identify correlations and other information of interest. In an embodiment, these and other outputs are available at any time during execution of the method of the present invention.

### IV. Systems

We evaluated methods of the present invention on data from eight production systems: four supercomputers, two data center clusters, and two autonomous vehicles. Table I summarizes these systems and logs, described herein. For this wide variety of systems—without modifying, instrumenting, or perturbing them in any way—our method builds online models of component and subsystem interactions, and these results are used for several system administration tasks.

Algorithms are used to convert raw data within these systems into anomaly signals and for picking predicates to generate indicator signals. These data are summarized in Table II. It has been our experience that the results of the present invention are not strongly sensitive to choices of these algorithms; for any reasonable choice of anomaly signals, our method tends to group similar components and detect similar lags.

A. Supercomputers

We use publicly-available logs from supercomputers that were in production use at national laboratories. These four systems, named Liberty, Spirit, Thunderbird, and Blue Gene/L (BG/L), vary in size by several orders of magnitude, ranging from 512 processors in Liberty to 131,072 processors in BG/L. The logs were recorded during production use of these systems and we make no modifications to them, whatsoever. An extensive study of these logs can be found elsewhere. The log messages below were generated consecutively by node sn313 of the Spirit supercomputer:
Jan 1 01:18:56 sn313/sn313 kernel: GM: There are 1 active subports for port 4 at close.
Jan 1 01:19:00 sn313/sn313 pbs_mom: task_check, cannot tm_reply to 7169.sadmin2 task 1
   We use an algorithm based on the frequency of terms in log messages to generate anomaly signals from the raw data. This is a reasonable algorithm to use if nothing is known of the semantics of the log messages; less frequent symbols carry more information than frequent ones.

TABLE I
The seven unmodified production system logs used in our case
studies. The ‘Comps’ column indicates the number of
logical components with instrumentation; some did not produce
logs. Real time is given in days:hours:minutes:seconds.

| System | Comps | Log Lines | Time Span |
|---|---|---|---|
| Blue Gene/L | 131,072 | 4,747,963 | 215:00:00:00 |
| Thunderbird | 9024 | 211,212,192 | 244:00:00:00 |
| Spirit | 1028 | 272,298,969 | 558:00:00:00 |
| Liberty | 445 | 265,569,231 | 315:00:00:00 |
| Mail Cluster | 33 | 423,895,499 | 10:00:05:00 |
| Junior | 25 | 14,892,275 | 05:37:26 |

TABLE II
Summary of the anomaly signals for this study. We omit ticks
in which no logs were generated. The ‘Signals’ column
indicates the total number of anomaly signals, which includes
the aggregate (‘Agg.’) and indicator (‘Ind.’) signals.

| System | Ticks | Tick = | Signals | Agg. | Ind. |
|---|---|---|---|---|---|
| Blue Gene/L | 2985 | 1 hr | 69,087 | 67 | 245 |
| Thunderbird | 3639 | 1 hr | 18,395 | 7 | 13,573 |
| Spirit | 11,193 | 1 hr | 4094 | 7 | 3569 |
| Liberty | 5362 | 1 hr | 372 | 4 | 124 |
| Mail Cluster | 14,405 | 1 min | 139 | 4 | 102 |
| Junior | 488,249 | 0.04 s | 25 | 0 | 0 |
| Stanley | 821,897 | 0.04 s | 16 | 0 | 0 |
| SQL Cluster | 13,007 | 1 min | 368 | 26 | 34 |

We generate indicator signals corresponding to known alerts in the logs. These signals indicate when the system or specific components generate a message matching a regular expression that is known to correspond to interesting behavior. For example, one message generated by Blue Gene/L reads, in part:

excessive soft failures, consider replacing the card

The administrators are aware that this so-called DDR_EXC alert indicates a problem. We generate one anomaly signal, called DDR_EXC, that is high whenever any component of BG/L generates this alert; for each such component (e.g., node1), there are also corresponding anomaly signals that are high whenever that component generates the alert (called node1/DDR_EXC) and whenever that component generates any alert (called node1/*).

We also generate aggregate signals for the supercomputers based on functional or topological groupings provided by the administrators. For example, Spirit has aggregate signals for the administrative nodes (admin), the compute nodes (compute), and the login nodes (login). For Thunderbird and BG/L, we also generate an aggregate signal for each rack.

B. Clusters

We also obtained logs from two clusters at Stanford University: 17 machines of a campus email routing server cluster and 9 machines of a SQL database cluster. Of the 17 mail cluster servers, 16 recorded two types of logs: a sendmail server log and a Pure Message log (a spam and virus filtering application). One system recorded only the mail log. The SQL cluster was unique among the systems we studied in that it recorded (a total of 271) numerical metrics using the Munin resource monitoring tool (e.g., bytes received, threads active, and memory mapped). For example, the following lines are from the memory swap metric:

2009-12-05 23:30:00 6.5536000000e+04

2009-12-06 00:00:00 6.3502367774e+04

Each such numerical log was used without modification as an anomaly signal. To generate anomaly signals for the nonnumeric content of these logs, we use a same term-frequency algorithm.

As with the supercomputers, indicator signals were generated for the textual parts of the cluster logs. Unlike the supercomputers, however, there are no known alerts, so we instead look for the strings ‘error,’ ‘fail,’ and ‘warn’ and name these signals ERR, FAIL, and WARN, respectively. These strings may turn out to be subjectively unimportant, but adding them to our analysis is inexpensive. Aggregate signals were also generated based on functional groupings provided by the administrators. For example, the mail cluster has one aggregate signal for the SMTP logs and another for the spam filtering logs; similarly, we aggregate disk-related logs in the SQL cluster into a signal called disk, memory-related logs into memory, etc.

C. Autonomous Vehicles

Stanley is the autonomous diesel-powered Volkswagen Touareg R5 developed at Stanford University that won the DARPA Grand Challenge in 2003. A modified 2006 Volkswagen Passat wagon named Junior placed second in the subsequent Urban Challenge. These distributed, embedded systems consist of many sensor components (e.g., lasers, radar, and GPS), a series of software components that process and make decisions based on these data, and interfaces with the cars themselves (e.g., steering and braking). In order to permit subsequent replay of driving scenarios, some of the components were instrumented to record inter-process communication. These log messages indicate their source, but not their destination (there are sometimes multiple consumers). The raw logs were used from the Grand Challenge and Urban Challenge, respectively. The following lines are from Stanley's Intertial Measurement Unit (IMU):
IMU −0.001320 −0.016830 −0.959640 −0.012786 0.011043 0.003487 1128775373.612672 rrl 0.046643
IMU −0.002970 −0.015510 −0.958980 −0.016273 0.005812 0.001744 1128775373.620316 rrl 0.051298

In the absence of expert knowledge, anomaly signals were generated based on deviation from what is typical: unusual terms in text-based logs or deviation from the mean for numerical logs. Stanley's and Junior's logs contained little text and many numbers, so we instead leverage a different kind of regularity in the logs, namely the interarrival times of the messages. We compute anomaly signals using an existing method based anomalous distributions of message interarrival times. We generate no indicator or aggregate signals for the vehicles.

### V. Results

Our results show that we can easily scale to systems with tens of thousands of signals and that we can describe most of a system's behavior with eigensignals that are orders of magnitude smaller than the original data; the behavioral subsystems and lags our method discovers correspond to real system phenomena and have operational value to administrators.

In the presently described analysis, we use a static k=20 eigensignals rather than attempt to dynamically adapt this number to match the variance in the data (as suggested elsewhere) but such adaptation can be done if desired. It was our experience for the presently described systems, however, that such adaptation resulted in overly frequent changes to k. We, therefore, set k to the largest value at which the analysis is able to keep up with the rate of incoming data. For the system that generated data at the highest rate (Junior), this number was approximately 20, and we use this value throughout. It is understood by those of ordinary skill in the art, however, that the parameters being described are exemplary and do not limit the scope of the present invention.

We tested decay values of 1.0 (no decay') and 0.96 (decay') and automatically seed the watch list with representatives from the subsystems, except where noted.

We performed all experiments on a MacPro with two 2.66 GHz Dual-Core Intel Xeons and 6 GB 667 MHz DDR2 FBDIMM memory, running Mac OS X version 10.6.4, using a Python implementation of the method.

We describe the performance of our analysis in terms of time and discuss the quality of the results. We focus on the mechanisms of the analysis, rather than their applications. We also discuss use cases for the present invention with examples from the data. There are a variety of techniques for visualizing the information produced by the present invention (e.g., graphs). We focus on the information the present invention produces and the use of that information.

A. Performance

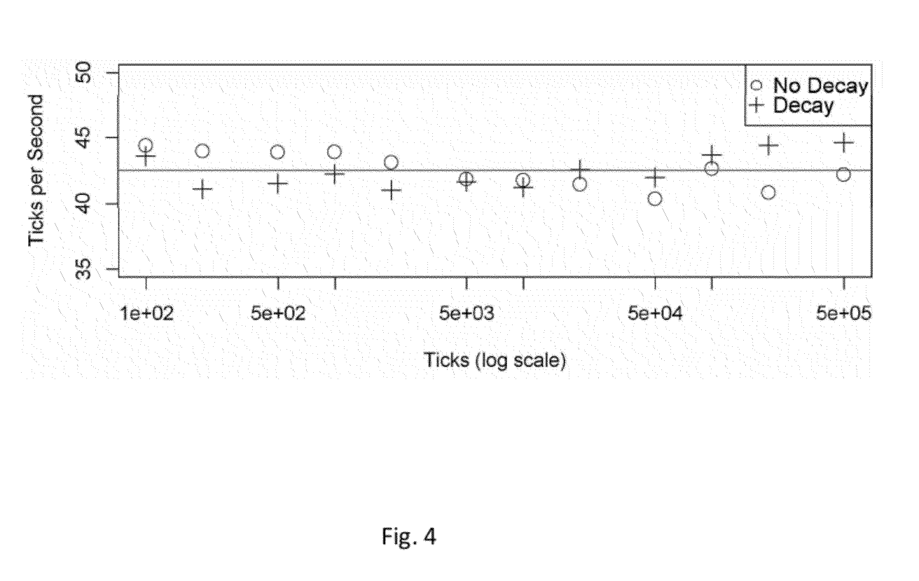

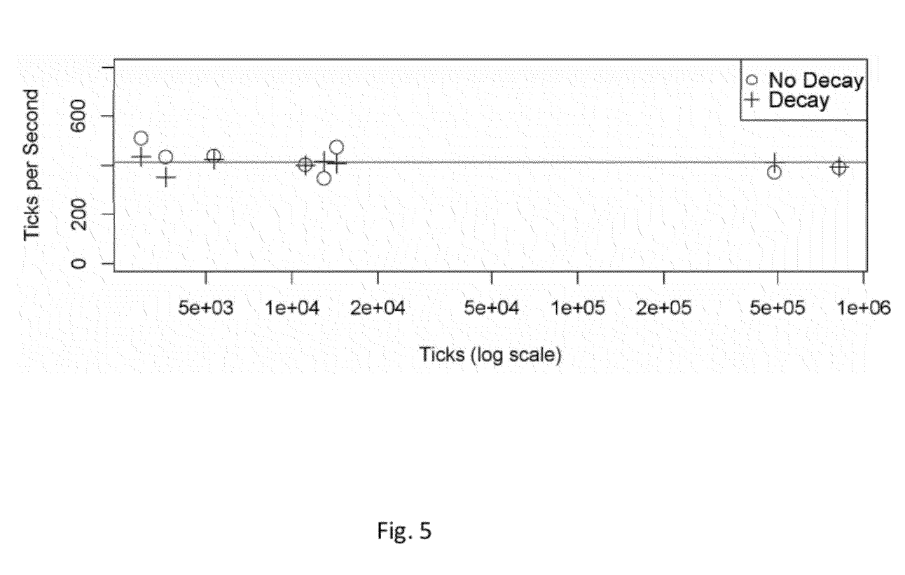

The present invention is able to keep up with the rate of data production for all the systems that we studied. The performance per tick does not degrade over time. FIGS. 4 and 5 show processing rate in ticks per second for the signal compression and lag correlation stages, respectively. Across more than three orders of magnitude of ticks, from 100 to around 821,000, there is no change in performance. This is in contrast to the other PCA algorithms whose running time grows linearly with number of ticks.

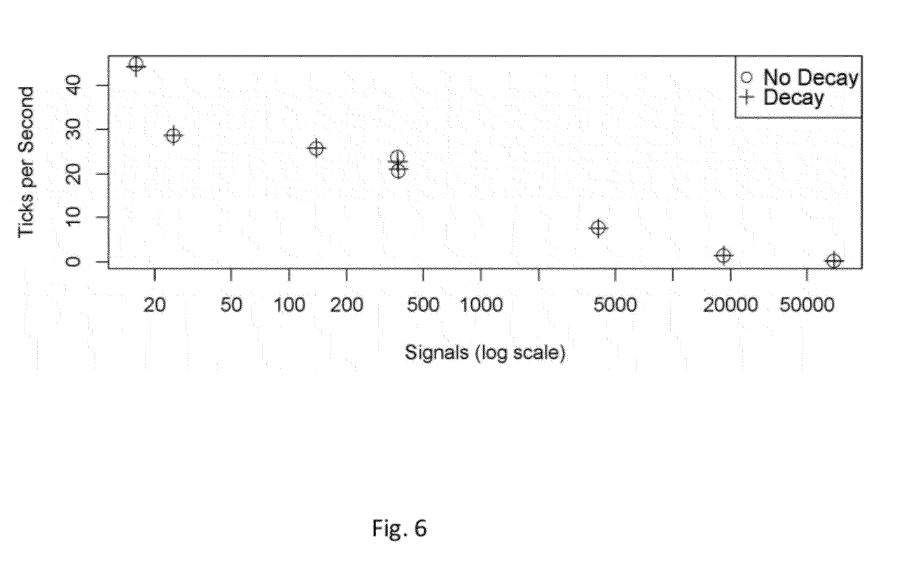

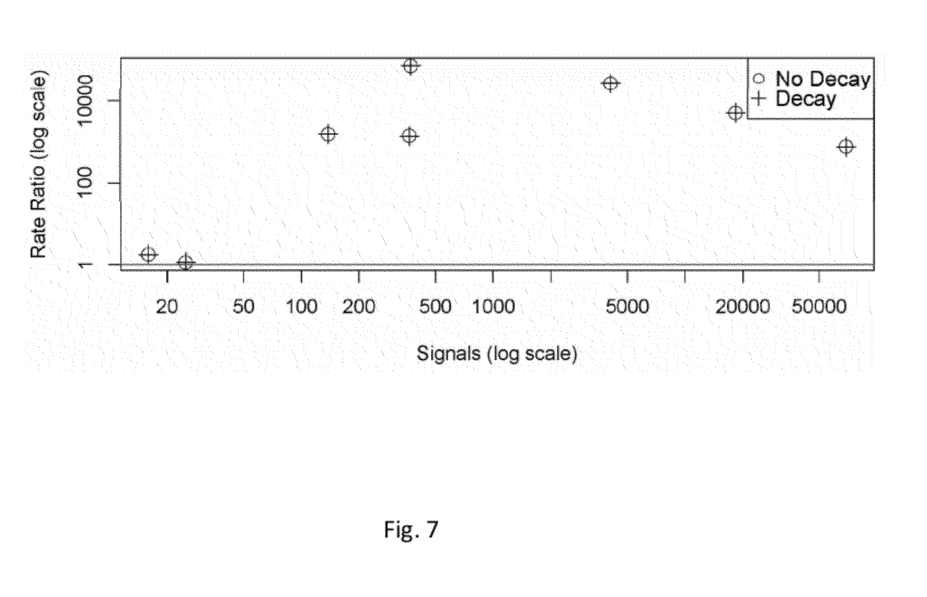

The compression stage scales well with the number of signals (see FIG. 6). For systems with a few dozen components, the entire PCA state can be updated dozens of times per second. Even with 70,000 signals, one tick takes only around 5 seconds. For such larger systems, however, the per-component rate at which instrumentation data is generated tends to be slower as well. It can, therefore, be desirable that the rate of processing exceed the rate of data generation. As noted above, we chose a number of subsystems that guaranteed this rate ratio was greater than 1 for all the systems we studied. The interesting fact is that for many of the larger systems the ratio was much higher (see FIG. 7). In other words, the compression stage is sufficiently fast to handle tens of thousands of signals that update with realistic frequency. In fact, it was Junior, one of the smaller systems, that had the smallest ratio of around 1.14. Junior's 25 anomaly signals were updating 25 times per second.

In the event that a system were to produce data too quickly, either because of the total number of signals or because of the update frequency, the number of subsystems (k), the size of the watch list, or the anomaly signal sampling rate could be reduced. This was not necessary for any of the systems analyzed. Note that bursts in the raw log data, which can exceed the average message rate by many orders of magnitude, are absorbed by the anomaly signal and do not factor into this discussion of data rate. Parallelizing both stages of the analysis of the present invention could yield even better performance.

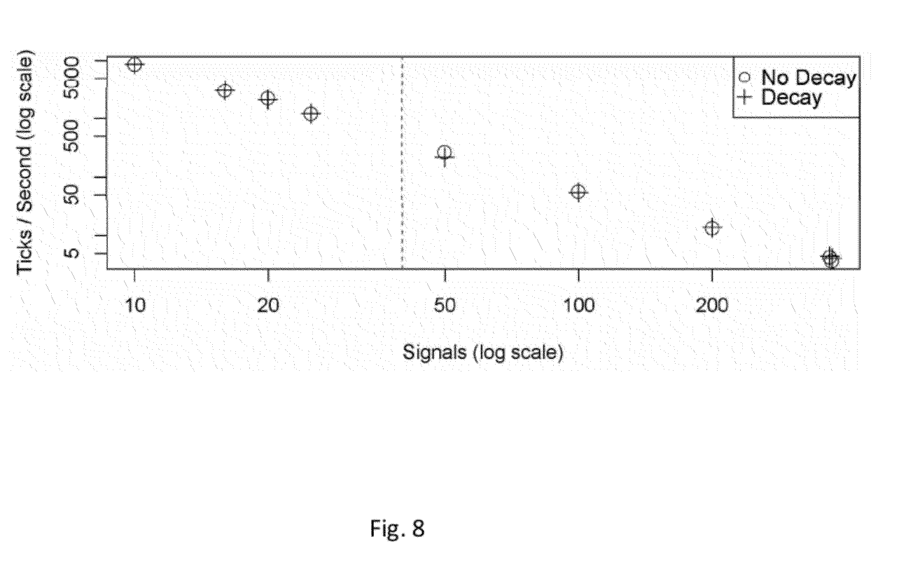

FIG. 8 shows how the lag correlation scales with the number of signals. As shown, trying to run the present invention on all 69,087 signals from BG/L, for example, could be intractable. An embodiment of the present invention addresses this issue by feeding the lag correlation stage only m signals: the eigensignals and signals on the watch list. The vertical line at 40 signals represents the number we use for most of the remaining experiments: 20 eigensignals and 20 representative signals in the watch list. Our method scales to supercomputer-scale systems because m<<n.

B. Eigensignal Quality

A measure called energy can be used to quantify how well the eigensignals describe the original signals. Let x_{τ,i} be the value of signal i at time τ. The energy Eₜ at time t is defined as

$${E}_{t} := \frac{\overline{1}}{t} {\sum }_{τ = 1}^{t} {\sum }_{i = 1}^{n} {x}_{τ , i}^{2} .$$

By projecting the eigensignals onto the weights, we can reconstruct an approximation of the original n anomaly signals. If the eigensignals are ideal, then the energy of the reconstructed signals will be equal to the energy of the original signals; in practice, using k<<n eigensignals and online approximations means that this fraction of reconstruction energy to original energy will be less than one.

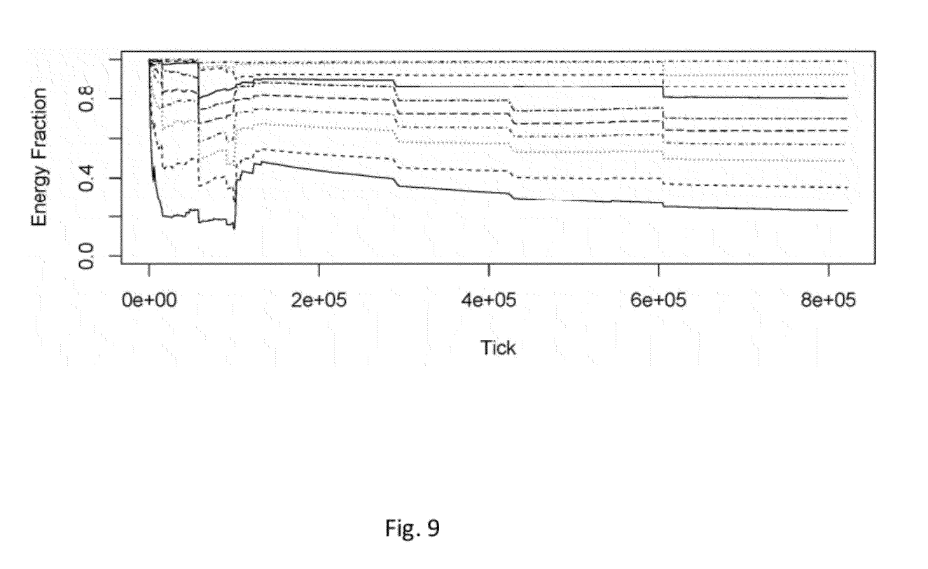

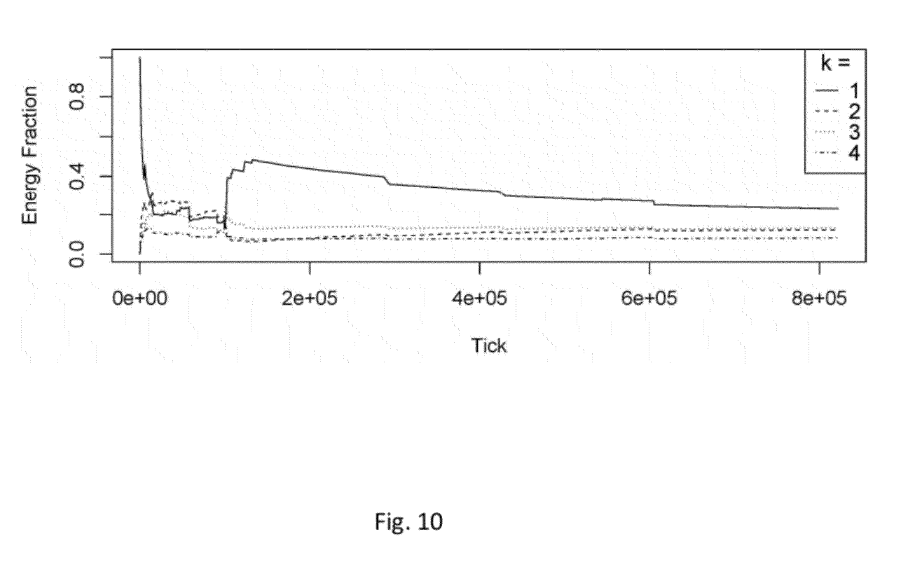

Consider the autonomous vehicle, Stanley, which has 16 original signals. FIG. 9 shows the energy ratio for the first ten eigensignals; the lowest line is for the first eigensignal only, the line above that represents the first two eigensignals, then the first three, and so on. FIG. 10 shows the incremental energy fraction; that is, the line for k=3 shows the amount of increase in the energy fraction over using k=2. Near the beginning of the log, the PCA is still learning about the system's behaviors, so the energy fraction is erratic. Over time, however, the ratio stabilizes. These experiments were without decay, so the energy fractions show how well the compression stage is able to model all the data it has seen so far. The first ten eigensignals are able to model almost 100% of the energy of Stanley's 16 original signals (i.e., almost 38% of the information in the anomaly signals was redundant).

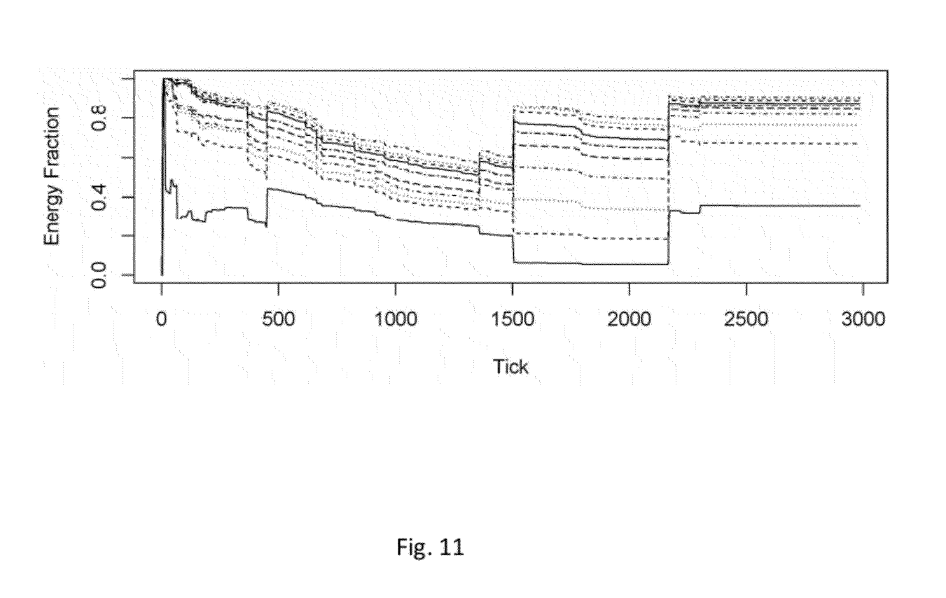

For larger systems, we find more signals tend to be correlated and the number of eigensignals needed per original signal decreases. Consider the cumulative energy fraction plot for BG/L in FIG. 11, which shows that the first eigensignal, alone, contains roughly 33% of all of the energy in the system.

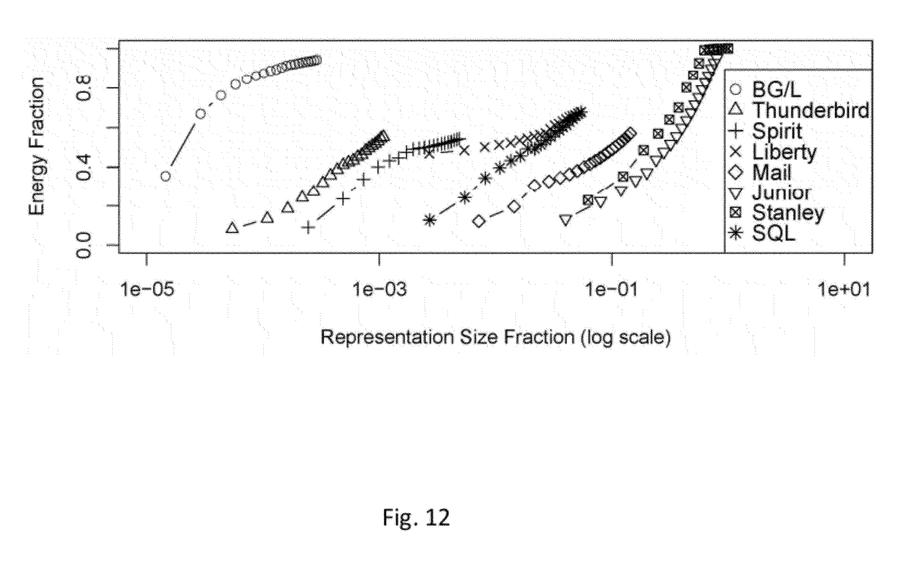

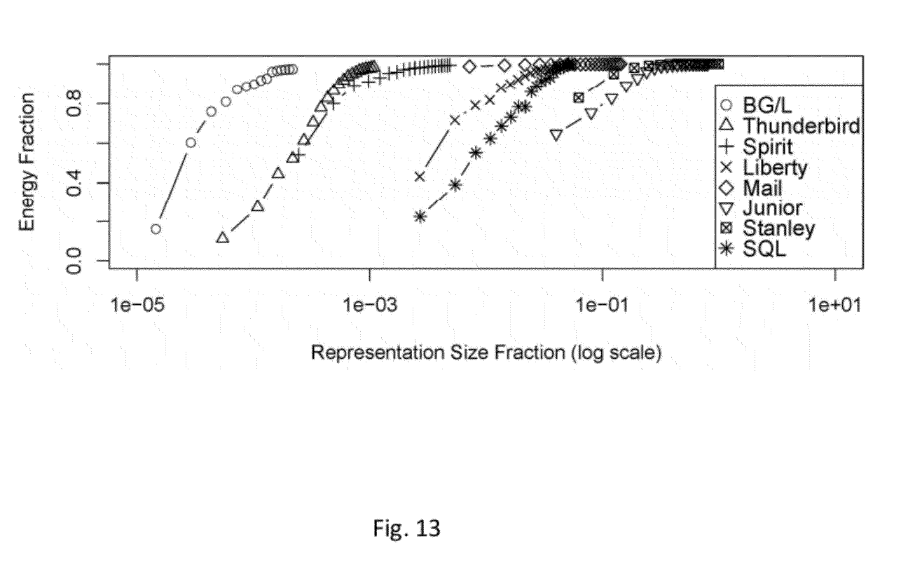

FIG. 12 shows what fraction of energy is captured by the first k eigensignals as a function of k/n. In other words, if the first stage of our method is thought of as lossy compression, the Figure shows how efficiently the data is being compressed and with what loss of information. For systems like BG/L, with many correlated subsystems, we can describe most of the behavior with a fraction of the original data. When we let old data decay (see FIG. 13), twenty eigensignals is enough to bring the energy fraction to nearly one; for the larger systems. This generally means that compression of several orders magnitude is possible with minimal information loss.

C. Behavioral Subsystems

We discuss some practical applications of the output of the first stage of our analysis: the behavioral subsystems. An eigensignal describes the behavior of a subsystem over time; the weights of the subsystem capture how much each original signal contributes to the subsystem. Components may interact with each other to varying degrees, and our notion of a subsystem reflects this fact.

1) Identifying Subsystems

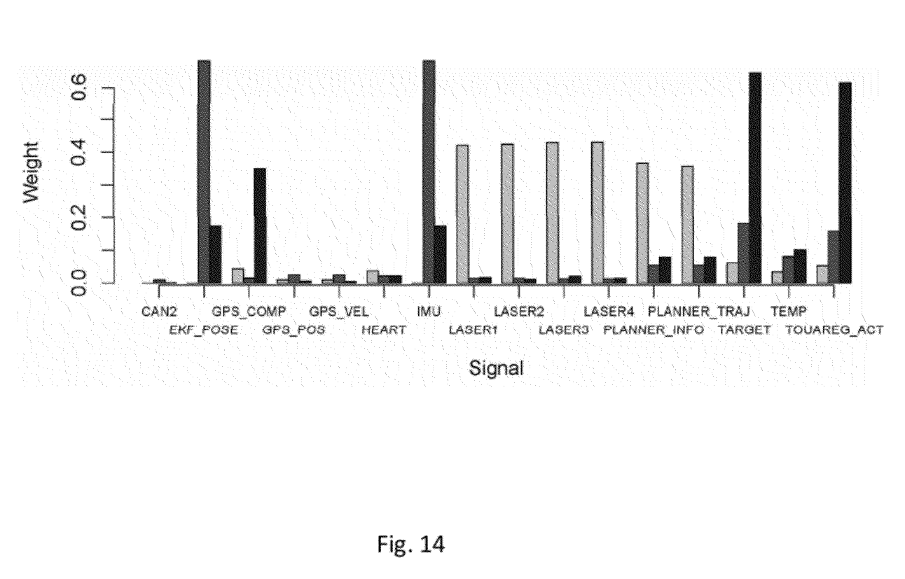

During the Grand Challenge race, Stanley experienced a critical bug that caused the vehicle to swerve around nonexistent obstacles. The Stanford Racing Team eventually learned that the laser sensors were sometimes misbehaving. But our analysis reveals a surprising interaction: the first subsystem is dominated by the laser sensors and the planner software (see FIG. 14). This interaction was surprising because there was initially no apparent reason why four physically separate laser sensors should experience anomalies around the same time. It was also interesting that the planner software was correlated with these anomalies more-so than with the other sensors. As it turned out, there was an uninstrumented, shared component of the lasers that was causing this correlated behavior and whose existence our method was able to infer. This insight was critical to understanding the bug.

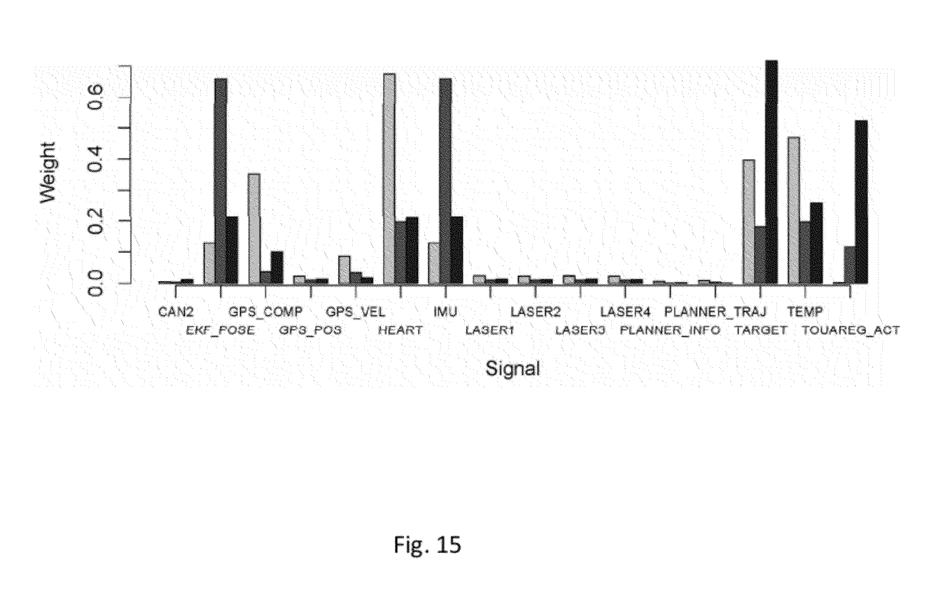

Administrators often ask, “What changed?” For example, does the interaction between Stanley's lasers and planner software persist throughout the log, or is it transient? The output of our analysis in FIG. 15, which only reflects behavior near the end of the log, shows that the subsystem is transient. Most of the anomalies in the lasers and planner software occurred near the beginning of the race and are long-since forgotten by the end. As a result, the first subsystem is instead described by signals like the heartbeat and temperature sensor (which was especially anomalous near the end of the race because of the increasing desert heat). We currently identify temporal changes manually, but we could automate the process by comparing the composition of subsystems identified by the signal compression stage. We discuss the temporal properties of Stanley's bug in more detail below.

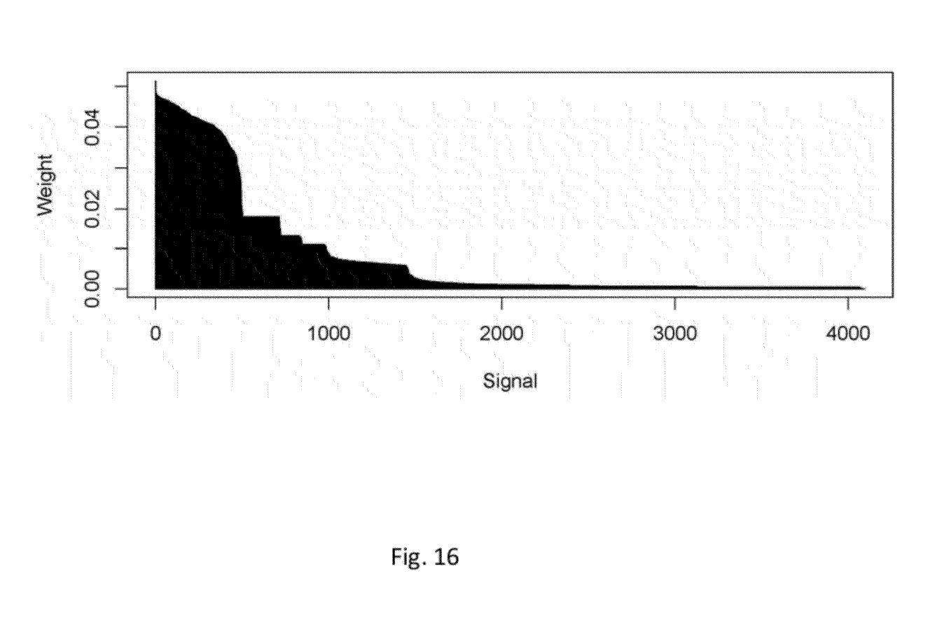

Subsystems can describe global behavior as well as local behavior. FIG. 16 shows the weights for Spirit's first subsystem, whose representative is the aggregate signal of all the compute nodes; this subsystem describes a system-wide phenomenon (nodes exhibit more interesting behavior when they are running jobs). This is an example of behavior an administrator might choose to filter out of the anomaly signals.

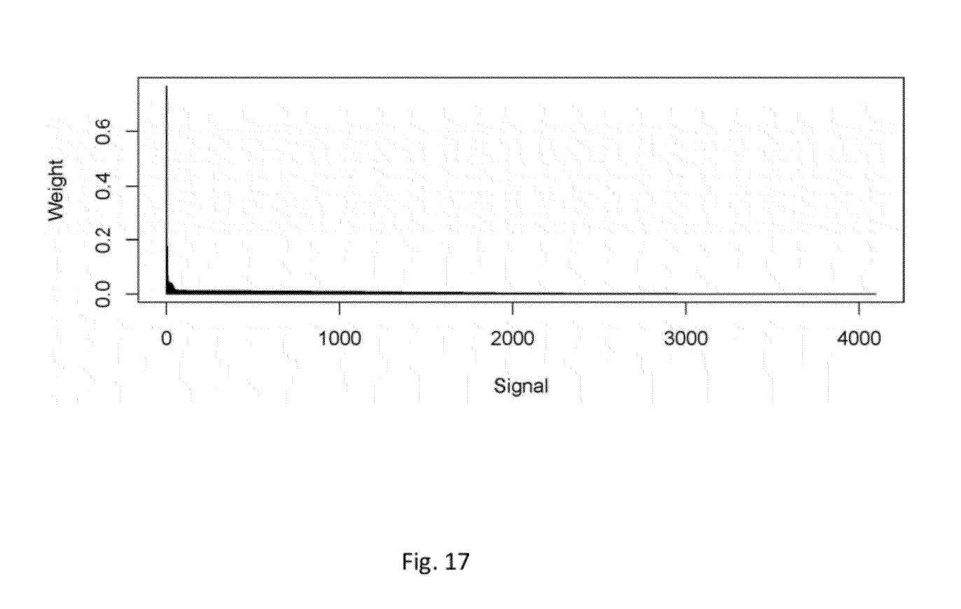

Meanwhile, the weights for Spirit's third subsystem, shown in FIG. 17, are concentrated in a catch-all logging signal, signals related to component sn111, and alert types R_HDA_NR and R_HDA_STAT (which are hard drive-related problems). This subsystem conveniently describes a specific kind of problem affecting a specific component, and knowing that those two types of alerts tend to happen together can help narrow down the root cause.

2) Refining Instrumentation

Subsystem weights elucidate the extent to which sets of signals are redundant and which signals contain valuable information. There is operational value in refining the set of signals to include only those that give new information.

In addition to identifying redundant signals, subsystems can draw attention to places where more instrumentation would be helpful. For example, our analysis of the SQL cluster revealed that slow queries were predictive of bad downstream behavior; this is then provides insight to the type of further instrumentation that could be useful.

In an embodiment of the invention, the information discussed here and elsewhere is output to a user. In an embodiment of the invention, tags and other information are also output to suggest or recommend action, including remedial action.

3) Representatives

When diagnosing problems in large systems, it is helpful to be able to decompose the system into pieces. Administrators currently do this using topological information (e.g., is the problem more likely to be in Rack 1 or Rack 2?). Our analysis shows that topology is often a reasonable proxy for behavioral groupings. The representative signal for the first subsystem of many of the systems are aggregate signals: the aggregate signal summarizing interrupts in the SQL cluster, the mail-format logs from Mail cluster, the set of compute nodes in Liberty and Spirit, the components in Rack D of Thunderbird, and Rack 35 of BG/L. On the other hand, our experiments also revealed a variety of subsystems for which the representative signals were not topologically related. In other words, topological proximity does not imply correlated behavior nor does correlation imply topological proximity. For example, based on FIG. 14, an administrator for Stanley would know to think about the laser sensors and planner software, together, as a subsystem.

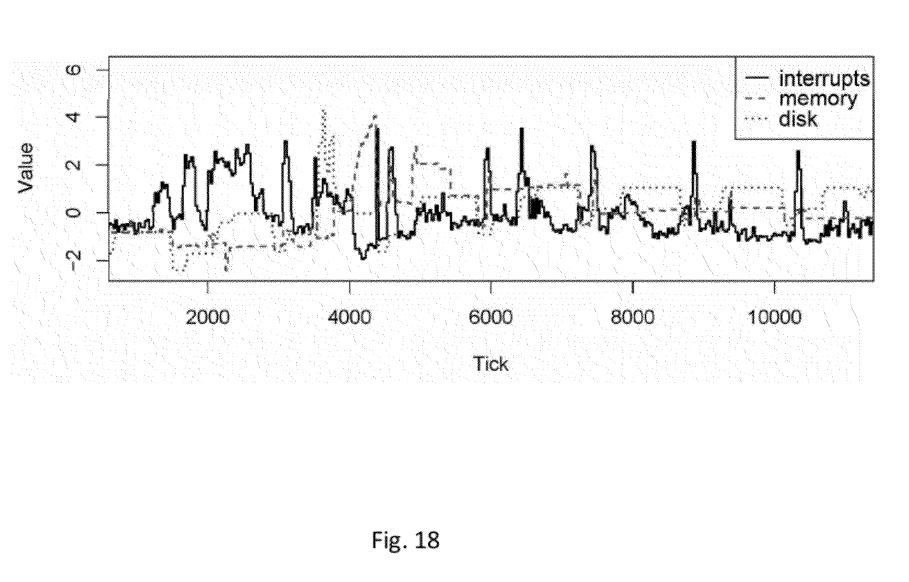

A representative signal is also useful for quickly understanding what behaviors a subsystem describes. FIG. 18 shows the anomaly signals of the representatives of the SQL cluster's first three subsystems. Based on the representatives, we can infer that these subsystems correspond to interrupts, application memory usage, and disk usage, respectively, and that these subsystems are not strongly correlated.

In an embodiment of the invention, the information discussed here and elsewhere is output to a user. In an embodiment of the invention, tags and other information are also output to suggest or recommend action, including remedial action.

4) Collective Failures

Behavioral subsystems can describe collective failures. On Thunderbird, there was a known system message suggesting a CPU problem: “kernel: Losing some ticks . . . checking if CPU frequency changed.” Among the signals generated for Thunderbird were signals that indicate when individual components output the message above. It turns out that this problem had nothing to do with the CPU. In fact, an operating system bug was causing the kernel to miss interrupts during heavy network activity. As a result, these messages were typically generated around the same time on multiple different components. Our method automatically notices this behavior and places these indicator signals into a subsystem: all of the first several hundred most strongly-weighted signals in Thunderbird's third subsystem were indicator signals for this “CPU” message. Knowing about this spatial correlation would have allowed administrators to diagnose the bug more quickly.

In an embodiment of the invention, the information discussed here and elsewhere is output to a user. In an embodiment of the invention, tags and other information are also output to suggest or recommend action, including remedial action.

5) Missing Values and Reconstruction

Our analysis can deal gracefully with missing data because it explicitly estimates the values it will observe during the current tick before observing them and adjusting the subsystem weights. If a value is missing, the estimated value may be used, instead.

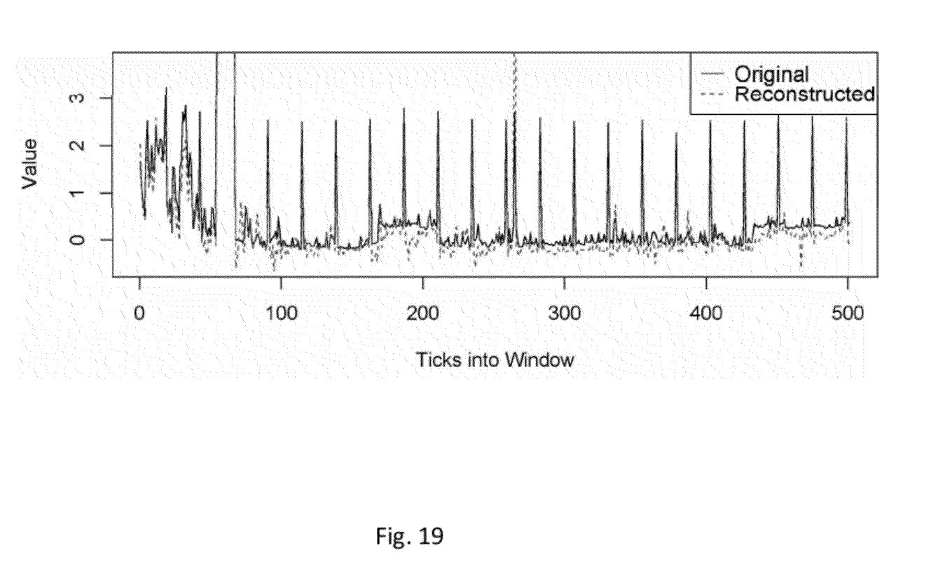

We can also output a reconstruction of the original anomaly signals using only the information in the subsystems (e.g., the weights and the eigensignals), meaning an administrator can answer historical questions about what the system was doing around a particular time, without the need to explicitly archive all the historical anomaly signals. FIG. 19 shows the reconstruction of a portion of Liberty's admin anomaly signal. Most of this behavior is captured by the first subsystem for which admin is representative.

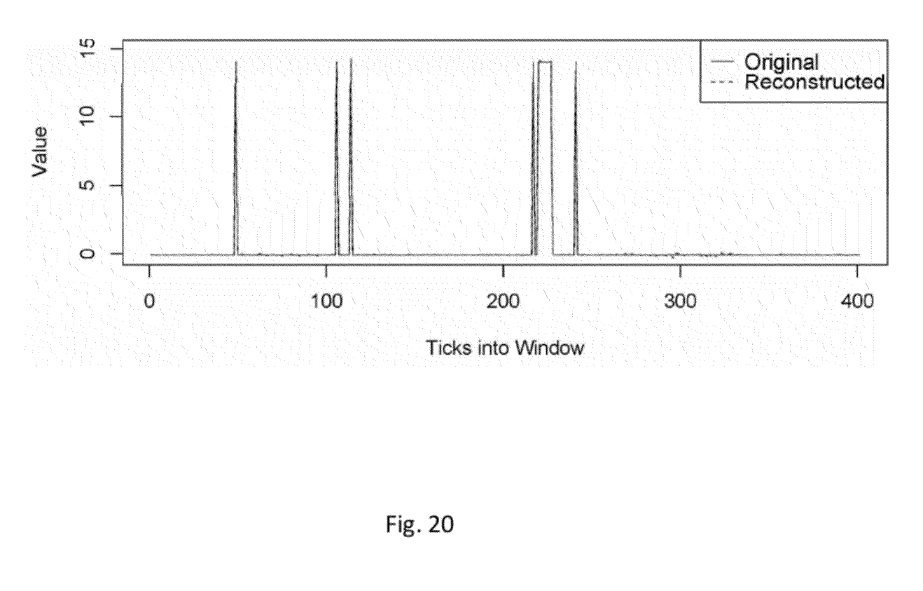

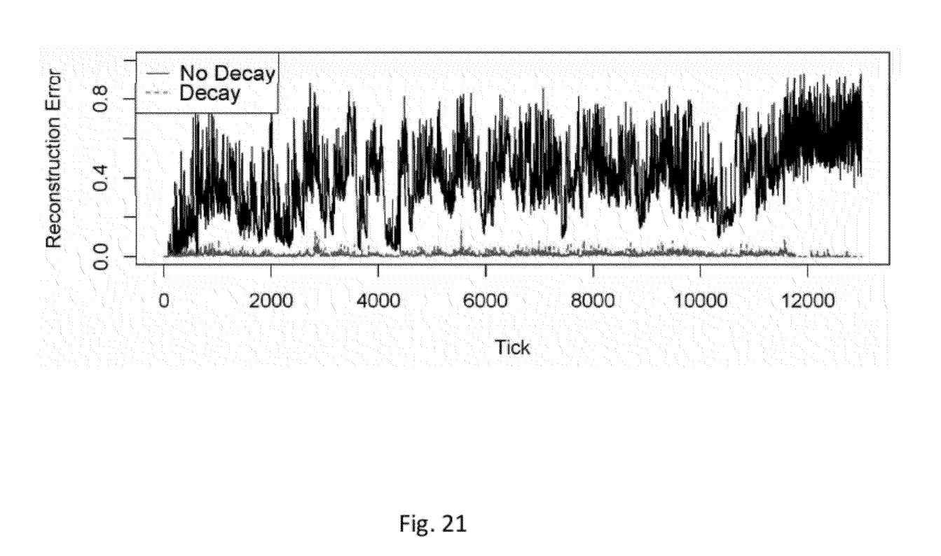

Allowing older values to decay permits faster tracking of new behavior at the expense of seeing long-term trends. FIG. 20 shows the reconstruction of one of Liberty's indicator signals, with decay. The improvement in reconstruction accuracy when using decay is apparent from FIG. 21, which shows the relative reconstruction error for the SQL cluster. The behavior of this cluster changed near the end of the log as a result of an upgrade. The analysis with decay adapts to this change more easily.

In an embodiment of the invention, the information discussed here and elsewhere is output to a user. In an embodiment of the invention, tags and other information are also output to suggest or recommend action, including remedial action.

D. Delays, Skews, and Cascades

In real systems, interactions may occur with some delay (e.g., high latency on one node eventually causes traffic to be rerouted to a second node, which causes higher latency on that second node a few minutes later) and may involve subsystems. We call these interactions cascades.

In an embodiment of the invention, the information discussed here and elsewhere is output to a user. In an embodiment of the invention, tags and other information are also output to suggest or recommend action, including remedial action.

1) Cascades

The logs were rich with instances of individual signals and behavioral subsystems with lag correlations. This includes the supercomputer logs, whose anomaly signals have 1-hour granularity. We give examples here.

We first describe a cascade in Stanley: the critical swerving bug mentioned previously. This bug has previously been analyzed only offline. Recall that the first stage of our analysis identifies one transient subsystem whose top four components are the four laser sensors and another subsystem whose top three components are the two planner components and the heartbeat component. The second stage discovers a lag correlation between these two subsystems with magnitude 0.47 and lag of 111 ticks (4.44 seconds). This agrees with the lag correlation between individual signals within the corresponding subsystems; for instance, LASER4 and PLANNER_TRAJ have a maximum correlation magnitude of 0.65 at a lag of 101 ticks. We explain how this knowledge could have prevented the swerving.

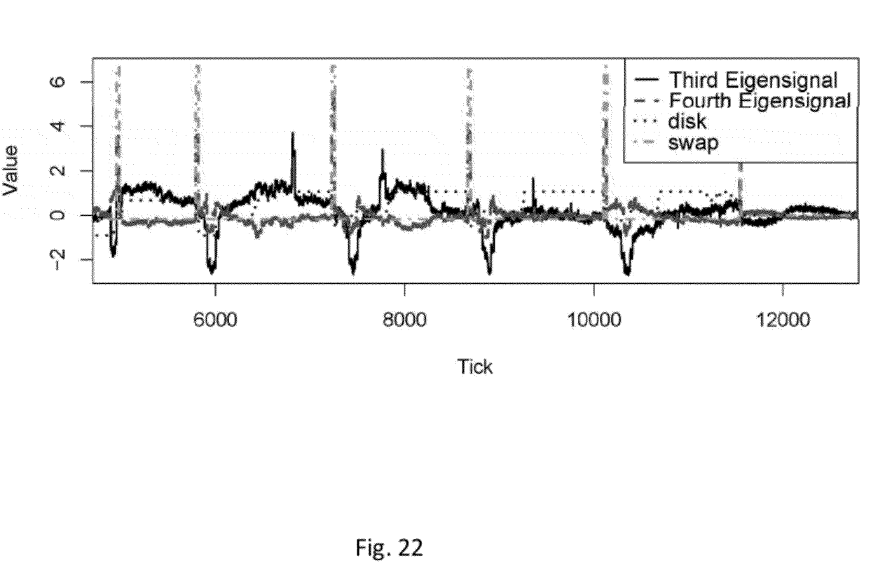

We described a cascade using three real signals called disk, forks, and swap. These three signals (renamed for conciseness) are from the SQL cluster and are the top components of the third subsystem and the representative of the fourth subsystem, respectively. Our method reports a lag correlation between the third and fourth subsystems of 30 minutes (see FIG. 22). The administrator had been trying to understand this cascading behavior for weeks; our analysis confirmed one of his theories and suggested several interactions of which he had been unaware.

The administrator of the SQL cluster ultimately concluded that there was not enough information in the logs to definitively diagnose the underlying mechanism at fault for the crashes. This is a limitation of the data, not the analysis. In fact, in this example, the method of the present invention identified the shortcoming in the logs (a future logging change is planned as a result) and, despite the missing data, pointed toward a diagnosis. Furthermore, we discuss below how this information is actionable even as the cascade is underway and

In an embodiment of the invention, the information discussed here and elsewhere is output to a user. In an embodiment of the invention, tags and other information are also output to suggest or recommend action, including remedial action.

2) Online Alarms

In addition to learning these cascades online, we can set alarms to trigger when the first sign of a cascade is detected. In the case of Stanley's swerving bug cascade, the Racing Team tells us Stanley could have prevented the swerving behavior by simply stopping whenever the lasers started to misbehave.

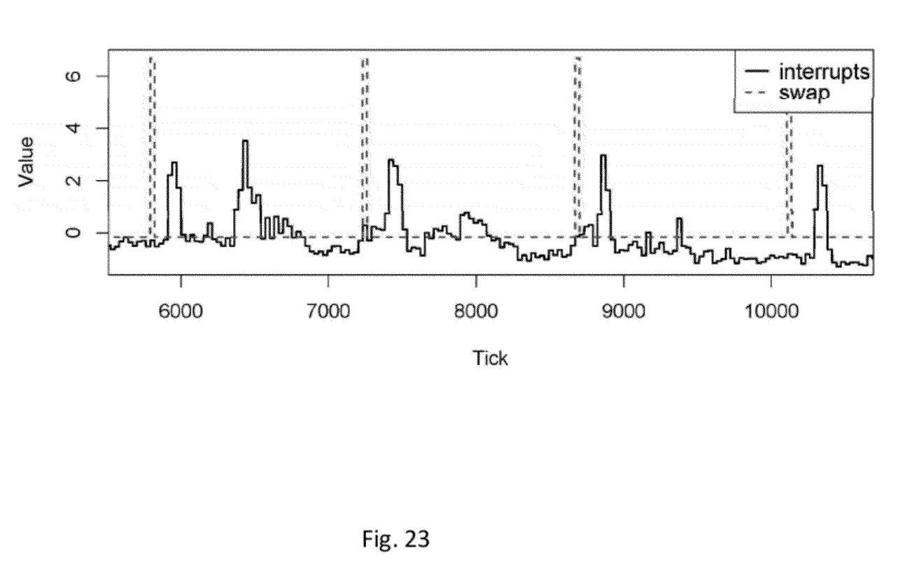

Some cascades operate on timescales that would allow more elaborate reactions or even human intervention. We tried the following experiment based on two of the lag-correlated signals reported by our method (plotted in FIG. 23): when swap rises above a threshold, we raise an alarm and see how long it takes before we see interrupts rise above the same threshold. We use the first half of the log to determine and set the threshold to one standard deviation from the mean; we use the second half for our experiments, which yield no false positives and raise three alarms with an average warning time of 190 minutes. Setting the threshold at two standard deviations gives identical results. Depending on the situation, advanced warning about these spikes could allow remedial action like migrating computation, adjusting resource provisions, and so on.

In an embodiment of the invention, the information discussed here and elsewhere is output to a user. In an embodiment of the invention, tags and other information are also output to suggest or recommend action, including remedial action.

3) Clock Skews

A cascade discovered between signals or subsystems that are known to act in unison may be attributable to clock skew. Without this external knowledge of what should happen simultaneously, there is no way to distinguish a clock skew from a cascade based on the data; our analysis can determine that there is some lag correlation, not the cause of the lag. If the user sees a lag that is likely to be a clock skew, our analysis provides the amount and direction of that skew, as well as the affected signals.

Although there were no known instances of clock skew in our data sets, we experimented with artificially skewing the timestamps of signals known to be correlated. We tested a variety of signals from different systems with correlation strengths varying from 0.264 to 0.999, skewing them from between 1 and 25 ticks. The amount of skew computed by our online method never differed from the actual skew by more than a couple of ticks; in almost all cases, the error was zero.

In an embodiment of the invention, the information discussed here and elsewhere is output to a user. In an embodiment of the invention, tags and other information are also output to suggest or recommend action, including remedial action.

E. Results Summary

Our results show that signal compression drastically increases the scalability of lag correlation and that this compression process identifies behavioral subsystems with minimal information loss. Experiments on large production systems reveal that our method can produce operationally valuable results under common conditions where other methods cannot be applied: noisy, incomplete, and heterogeneous logs generated by systems that we cannot modify or perturb and for which we have neither source code nor correctness specifications.

We have shown an efficient, two-stage, online method for discovering interactions among components and groups of components, including time-delayed effects, in large production systems. The first stage compresses a set of anomaly signals using a principal component analysis and passes the resulting eigensignals and a small set of other signals to the second stage, a lag correlation detector, which identifies time-delayed correlations. We show, with real use cases from eight unmodified production systems, that understanding behavioral subsystems, correlated signals, and delays can be valuable for a variety of system administration tasks: identifying redundant or informative signals, discovering collective and cascading failures, reconstructing incomplete or missing data, computing clock skews, and setting early-warning alarms.

In an embodiment described above, the method of the present invention uses timestamped measurements from components and a method for transforming these measurements into anomaly signals. In this way, the present invention is applicable computational systems (clusters, supercomputers, embedded systems) but also to noncomputational systems (e.g., city traffic or biological systems). The application to these systems enables a greater understanding of how components and subsystems interact.

The present invention is generally applicable to systems management to diagnose bugs, build system models, predict the effects of modifications, optimize performance, and engineer better systems. In intelligence, the present invention is useful for inferring the relationships and interactions of individuals even when the specific communication channels are unknown. In applications in biology and medicine, the present invention is useful in inferring the function and interactions of complex biological systems even when the specific mechanisms are poorly understood or when the measurement data is sparse. There are, of course, many more applications for the present invention as would be understood by one of ordinary skill in the art.

It should be appreciated by those skilled in the art that the specific embodiments disclosed above may be readily utilized as a basis for modifying or designing other image processing algorithms or systems. It should also be appreciated by those skilled in the art that such modifications do not depart from the scope of the invention as set forth in the appended claims.

What is claimed is:

1. A method for analyzing the performance of a system, comprising:
receiving a first set of signals;
converting the first set of signals into a first set of anomaly signals;
converting a first subset of the first set of anomaly signals into a first set of compressed anomaly signals;
identifying a first set of watch signals from the first set of anomaly signals;
performing a lag correlation of at least one compressed anomaly signal from the first set of compressed anomaly signals with at least one watch list signal from the first set of watch list signals; and
identifying a lag correlation of interest.

2. The method of claim 1, wherein the compressed anomaly signals are generated using a principal components analysis.

3. The method of claim 1, wherein weights are assigned to the first set of compressed anomaly signals.

4. The method of claim 1, wherein weights are assigned to the first set of watch signals.

5. The method of claim 1, further comprising performing a lag correlation of at least one compressed anomaly signal from the first set of compressed anomaly signals with another compressed anomaly signal from the first set of compressed anomaly signals.

6. The method of claim 1, further comprising performing a lag correlation of at least one watch list signal from the first set of watch list signals with another watch list signal from the first set of watch list signals.

7. The method of claim 1, wherein the first set of compressed anomaly signals are selected to substantially represent the system

8. A method for analyzing the performance of a system, comprising:
receiving a first set of signals;
converting the first set of signals into a first set of anomaly signals;
converting a first subset of the first set of anomaly signals into a first set of compressed anomaly signals;
identifying a first set of watch signals from the first set of anomaly signals;
performing a lag correlation of at least one compressed anomaly signal from the first set of compressed anomaly signals with another compressed signal from the first set of compressed anomaly signals; and
identifying a lag correlation of interest.

9. The method of claim 8, wherein the compressed anomaly signals are generated using a principal components analysis.

10. The method of claim 8, wherein weights are assigned to the first set of compressed anomaly signals.

11. The method of claim 8, wherein weights are assigned to the first set of watch signals.

12. The method of claim 8, further comprising performing a lag correlation of at least one compressed anomaly signal from the first set of compressed anomaly signals with a watch signal from the first set of watch signals.

13. The method of claim 8, further comprising performing a lag correlation of at least one watch list signal from the first set of watch list signals with another watch list signal from the first set of watch list signals.

14. The method of claim 8, wherein the first set of compressed anomaly signals are selected to substantially represent the system

15. A method for analyzing the performance of a system, comprising:
receiving a first set of signals;
converting the first set of signals into a first set of anomaly signals;
converting a first subset of the first set of anomaly signals into a first set of compressed anomaly signals;
identifying a first set of watch signals from the first set of anomaly signals;
performing a lag correlation of at least one compressed anomaly signal from the first set of compressed anomaly signals with at least one watch list signal from the first set of watch list signals;
performing a lag correlation of at least one compressed anomaly signal from the first set of compressed anomaly signals with another compressed signal from the first set of compressed anomaly signals; and
identifying a lag correlation of interest.

16. The method of claim 15, wherein the compressed anomaly signals are generated using a principal components analysis.

17. The method of claim 15, wherein weights are assigned to the first set of compressed anomaly signals.

18. The method of claim 15, wherein weights are assigned to the first set of watch signals.

19. The method of claim 15, further comprising performing a lag correlation of at least one watch list signal from the first set of watch list signals with another watch list signal from the first set of watch list signals.

20. The method of claim 15, wherein the first set of compressed anomaly signals are selected to substantially represent the system.
